(19) United States
(12) Patent Application Publication
(10) Pub. No.: US 2014/0070067 A1
(43) Pub. Date: Mar. 13, 2014

(54) VEHICLE SEAT SPACER ARRANGEMENT

(71) Applicant: Volvo Car Corporation, Goteborg (SE)

(72) Inventor: Tony Jonsson, Alingsas (SE)

(73) Assignee: Volvo Car Corporation, Goteborg (SE)

(21) Appl. No.: 14/011,646

(22) Filed: Aug. 27, 2013

(30) Foreign Application Priority Data
Sep. 11, 2012 (EP) 12183831.2

(51) Int. Cl. B60N 2/015

(52) U.S. Cl. CPC B60N 2/015
USPC 248/429

(57) ABSTRACT

The present invention relates to a light-weight, space efficient spacer arrangement for distancing a vehicle seat from a vehicle floor structure. The spacer arrangement comprises a first and a second spacing element, each having a spacing element seat side adapted to be positioned towards the vehicle seat, and a spacing element floor side adapted to be positioned towards the vehicle floor structure. The first and second spacing elements are of truncated cone or pyramid shape flared from the spacing element seat side towards the spacing element floor side, and are of dimensions and material capable of carrying sufficient weight and loads. Furthermore, the first and second spacing elements are adapted to bear weight and loads applied to the vehicle seat.

### CROSS REFERENCE TO RELATED APPLICATIONS

The present application claims priority to European Patent Application No. 12183831.2, filed on Sep. 11, 2012, the entire contents of which are hereby incorporated by reference for all purposes.

### TECHNICAL FIELD

The present invention relates to a spacer arrangement for distancing a vehicle seat from a vehicle floor structure.

### BACKGROUND OF THE INVENTION

Throughout a variety of vehicles, platforms and varying models, numerous different vehicle seat implementations are represented. Seats may differ in size and design, they may be arranged in the front or further back of the vehicle; some seats may be adjustable horizontally and vertically and furthermore have the ability to be tilted. Regardless of the variations, vehicle seats share the need for appropriate anchoring with the vehicle floor, or commonly with the vehicle chassis. U.S. Pat. No. 629,912, for instance, describes a fixing device for mounting a seat part of a seat on a vehicle floor. Although seemingly providing a reliable implementation for anchoring of a seat, the solution suggested does not appear to, in a sufficient manner, target seats intended for relatively high seat positioning. That is, in larger cars such as for instance SUVs (sport utility vehicles), seats are commonly positioned higher up in relation to the vehicle floor as compared to a normal sized car. Accordingly, positioning of for instance a SUV front seat may require an additional structure arranged between the seat and the chassis, for distancing the seat from the floor. For robustness, such distancing structures may be bulky and heavy, and may furthermore require a large number of screws or bolts for fastening to the seat and chassis. In view of the continuous striving within the automotive sector for reduction of package space as well as number of components required by the implementation, weight thereof and naturally cost, there is a need for the provision of a distancing structure being compact and light-weight.

### SUMMARY OF THE INVENTION

According to the invention, the above need is at least partly met by a spacer arrangement for distancing a vehicle seat from a vehicle floor structure. The spacer arrangement comprises a first and a second spacing element, each having a spacing element seat side adapted to be positioned towards the vehicle seat, and a spacing element floor side adapted to be positioned towards the vehicle floor structure. The first and second spacing elements are of truncated cone or pyramid shape flared from the spacing element seat side towards the spacing element floor side. Furthermore, the first and second spacing elements are adapted to bear weight and loads applied to the vehicle seat.

By arranging a spacer arrangement in accordance with the present invention between a vehicle seat and vehicle floor structure, there is provided a solution to position the vehicle seat at a sufficient height above the vehicle floor. The vehicle seat, hereinafter referred to as seat, may be any seat applicable for the implementation at hand, for instance a driver seat, passenger seat or a seat for a second or perhaps a third row passenger. The seat may for instance be provided with seat rails enabling the seat to be adjusted in a forward and backward manner, but fixed seats are likewise plausible. The vehicle may be of any preferred type, and the vehicle floor structure, hereinafter referred to as floor structure, may be represented by an arbitrary chassis not restricted to any specific platform or model. Furthermore, the spacer arrangement of the present invention may be combined with other structures providing supplementary distancing of the seat from the floor structure. That is, the novel spacer arrangement may for instance be positioned beneath a front portion of a seat, while another distancing structure may be provided beneath a back portion of the seat.

With the introduction of a first and a second spacing element, each having a spacing element seat side adapted to be positioned towards the vehicle seat, and a spacing element floor side adapted to be positioned towards the vehicle floor structure, there are at least two interface positions provided at which the spacer arrangement may interact with the seat as well as floor structure. It should be noted that the spacer arrangement does not necessarily need to be directly adjacent the vehicle seat; there may be one or several intermediate layers, such as for instance seat rails, provided between the spacer arrangement and the vehicle seat. Similarly, the spacer arrangement does not necessarily need to be directly adjacent the vehicle floor structure; there may be one or several intermediate layers, such as any sort of attachment arrangement, provided between the spacer arrangement and the vehicle floor structure.

With the introduction of first and second spacing elements of truncated cone or pyramid shape flared from the spacing element seat side towards the spacing element floor side, the spacing elements are of a shape that may be manufactured in an efficient manner. Furthermore, the truncated cone or pyramid shape may facilitate fixation of for instance a vehicle mat intended to cover the floor structure (and/or intermediate layers and/or vehicle floor). Additionally, the truncated cone or pyramid shape may distribute loads arising from a possible vehicle accident in an efficient manner, independently of direction of such an impact.

A cross-section of the spacing elements' truncated cone or pyramid shape may vary, and may for instance be circular or oval, or have another rounded shape. The cross-section may in other implementations be a polygon, multifaceted with at least three sides, although four or more may be beneficial. Furthermore, the body of the spacing element may take on different designs in different embodiments, varying from being solid to hollow. In common, however, is that it is preferred for the body to allow for at least one anchoring member protruding from the floor structure to the seat (or vice versa), to pass through the respective spacing element. Thereby, each respective spacing element not only supports distancing of the seat from the floor structure, but additionally enables for the seat to be attached to the floor structure in a convenient manner. Accordingly, rather than being required to utilize separate screws for fastening the distancing structure with the floor structure and seat, the truncated cone or pyramid shape may enable for the seat to be fastened with the floor structure by means of a single anchoring member penetrating through the respective spacing element. Thereby, assembly may be facilitated, and assembly times along with weight and cost may be reduced. Furthermore, the efficient shape of the truncated cone or pyramid provides reduced package space, and subsequently better foot space for second row passengers should the invention be applied to, for instance, a driver seat.

It should be noted that “truncated cone or pyramid shape” of a spacing element is intended to be interpreted in a broad manner, also including minor deviations. Such a minor deviation may for instance be represented by the spacing element seat side and/or spacing element floor sides being slightly bevelled, subsequently the sides slightly angled, to facilitate for the seat to be arranged with e.g. the front portion higher above the vehicle floor than the back portion. Another such a minor deviation may represent the spacing element envelope wall of one or more of the spacing elements comprising one or several optional cavities adapted for fitting one or several anchoring members, such as screws or bolts. Thereby, supplementary fastening of the spacing element to the seat and/or floor structure may be supported. Yet another such minor deviation may be represented by one or both of the spacing elements additionally comprising brims with flange-like shapes. Said brims may surround the spacing element seat side and/or the spacing element floor side, to thereby improve stability and strength of the spacing element. The brims may take on varying widths and shapes, and subsequently be adapted to suit the implementation at hand.

Not least, the present invention furthermore specifies the first and second spacing elements being adapted to bear weight and loads applied to the vehicle seat. Accordingly, with the truncated cone- or pyramid-shaped spacing elements being of sufficient dimensions and material capable of carrying sufficient weight and loads, a light-weight, space efficient spacer arrangement for distancing the seat from the floor structure is provided.

The spacing elements may be manufactured from any kind of suitable material such as concrete, metals such as steel, or iron. A preferred selection of suitable materials are light-weight materials, whereby according to an embodiment, the first and/or the second spacing element comprises a light-weight material, such as one or more of the materials selected from the list of: aluminum, magnesium based alloys, polymeric materials such as composites, reinforced polymeric material, e.g. carbon reinforced fiber polymeric material. Thereby, provided that suitable dimensions of the spacing elements are selected, spacing elements of light-weight material may have sufficient load-bearing characteristics required for carrying weight and loads applied to the vehicle seat. It should be noted that other sections of the spacer arrangement likewise may comprise such light-weight material(s).

According to another embodiment, the first and/or the second spacing element has a spacing element height stretching from the spacing element seat side to the spacing element floor side. The spacing element height ranges from 10 to 150 mm, and preferably from 60 to 100 mm. With the suggested former, broader height span, the spacing elements may be of height dimensions suitable for a variety of vehicle types, platforms, models and seats. With the suggested latter, narrower height span, seat heights suitable for e.g. vehicles such as SUVs may be targeted for implementation. The respective spacing elements may furthermore be of different heights, should such an implementation be suitable for the implementation at hand. A spacing element positioned beneath a front portion of a seat may, for instance, be of greater height than a spacing element positioned beneath a back portion.

According to one embodiment, the spacing element seat side is circular, and an outer spacing element seat diameter of the spacing element seat side ranges from 15 to 80 mm, and preferably from 30 to 60 mm. By outer spacing element seat diameter is here meant the outer edge perimeter diameter of the spacing element side facing the seat. According to another embodiment, the spacing element floor side is circular, and an outer spacing element floor diameter of the spacing element floor side ranges from 20 to 100 mm, and preferably from 40 to 80 mm. By outer spacing element floor diameter is here meant the outer edge perimeter diameter of the spacing element side facing the floor structure. With the suggested diameter spans, the spacing element seat side, as well as the spacing element floor side, may be of appropriate dimensions in view of for instance load-bearing characteristics versus weight of the spacing element. It should be noted that the outer spacing element seat and floor sides being defined as “circular” should be interpreted in a broad manner, likewise including “almost circular” and “close to circular”.

As previously mentioned, each spacing element may additionally comprise a brim with a flange-like shape surrounding the spacing element seat side and/or the spacing element floor side. It should be noted that such a brim, in this context, is not to be considered comprised in above mentioned outer spacing element seat diameter and/or outer spacing element floor diameter.

According to yet another embodiment, at least one of said first and second spacing elements is monolithic, comprising a spacing element envelope wall defining a tubular void adapted for encompassing an anchoring member. Thereby, a solid spacing element is presented, which may be manufactured in a convenient manner. Such a monolithic spacing element may preferably, although not necessarily, be of a plastic material, in order to keep weight down. The tubular void may take on different forms, and may for instance be adapted to loosely encompass the anchoring member, e.g. screw or bolt. Alternatively, the tubular void may be adapted to encompass the anchoring member in a tight manner. Thereby, there is provided a spacing element supporting screw pre-tension loads, with a straight efficient load path in tension and compression, and in horizontal loads arising from, for instance, a possible vehicle accident. The tubular void may further be threaded, to thereby provide additional engagement of the anchoring member with the spacing element.

In order to enable for further weight reduction, the spacing elements may be designed to be hollow. Consequently, according to one embodiment, a spacing element thickness of a spacing element envelope wall of the first and/or second spacing element ranges from 1 to 8 mm, and preferably from 1.5 to 5 mm. With the suggested thickness spans, the spacing element envelope walls may be of appropriate dimensions in view of load-bearing characteristics versus weight of the spacing element. The spacing element thickness may be constant along the perimeter and height of the spacing element, although likewise plausible is an envelope wall thickness varying along the envelope surface.

According to one embodiment, at least one of the spacing elements comprises a tubular support element centrally arranged inside the corresponding spacing element. Furthermore, the tubular support element has a tubular support element seat side adapted to be positioned towards the vehicle seat and a tubular support element floor side adapted to be positioned towards the vehicle floor structure. The tubular support element is adapted to bear weight and loads applied to the vehicle seat. With the introduction of a tubular support element centrally arranged inside a spacing element, additional supporting structures for distancing the seat from the floor structure are provided. By arranging each tubular support element centrally, consideration is given to symmetry. It should be noted, however, that “centrally arranged” is intended to be interpreted in a broad manner, likewise including “almost centrally arranged” and “close to centrally arranged”.

Since each tubular support element has a tubular support element seat side adapted to be positioned towards the seat and a tubular support element floor side adapted to be positioned towards the floor structure, the tubular support elements may interact with the seat as well as the floor structure. It should be noted that the tubular support elements are not necessarily directly adjacent the vehicle seat; there may be one or several intermediate layers, such as for instance seat rails, provided between each tubular support element and the seat. Similarly, the tubular support elements are not necessarily directly adjacent the floor structure; there may be one or several intermediate layers, such as an attachment arrangement, provided between each tubular support element and the floor structure. Furthermore, the tubular support element seat side and/or tubular support element floor side may be slightly bevelled, subsequently the sides slightly angled. Additionally, the tubular support element seat side may be in level with the corresponding spacing element seat side, and the tubular support element floor side may be in level with the corresponding spacing element floor side. Thereby, the design of the spacer arrangement may be simplified.

Furthermore, the tubular support elements may comprise a light-weight material, such as one or a combination of those suggested in the foregoing in conjunction with the spacing elements, and each may be of the same material as the corresponding spacing element. Alternatively, the tubular support elements may comprise material differing from the material of the corresponding spacing element, whereby the different material characteristics may provide a desirable combination. That is, a spacing element of for instance a light-weight composite material, and a corresponding tubular support element of metal, may be an efficient hybrid solution which may strengthen the design.

Furthermore, the respective tubular support elements may take on different forms, and may for instance be adapted to loosely encompass an anchoring member, e.g. screw or bolt. Alternatively, the respective tubular support elements may be adapted to encompass an anchoring member in a tight manner. Thereby, there is provided a tubular support element which, along with the corresponding spacing element, supports screw pre-tension loads, with a straight efficient load path in tension and compression, and further supports horizontal loads arising from, for instance, a possible vehicle accident. The tubular support element may further be threaded to thereby provide additional engagement of an anchoring member with the tubular support element.

Optionally, one or more of the tubular support elements may comprise additional brims with flange-like shapes. Such brims may surround the tubular support element seat side and/or the tubular support element floor side, to thereby improve stability and strength of the tubular support element. The brims may take on varying widths and shapes, and subsequently be designed to suit the implementation at hand.

Not least, with the first and second tubular support elements furthermore adapted to bear weight and loads applied to the vehicle seat, e.g. with the first and second tubular support elements being of sufficient dimensions and material, the tubular support elements may assist the spacing elements in carrying weight and loads in an efficient manner.

According to a further embodiment, at least one of the spacing elements is formed in one unitary piece of material with the corresponding tubular support element. For example, first spacing element 21 and first tubular element 33 may be formed in one unitary piece of material. Thereby, a spacing element and a tubular support element is represented by a single part rather than two separate parts, which may make handling as well as assembly more convenient. The spacing element and the tubular support element may, for instance, be integrated in that the level of the spacing element seat side coincides with the tubular support element seat side, with the spacing element seat side comprising the tubular support element seat side. According to another example, forming of the first tubular support element and the first spacing element in one unitary piece of material may be accomplished by the spacing element floor side comprising the tubular support element floor side. In some examples, every one of the spacing elements is formed in one unitary piece of material with the corresponding tubular support elements; in other examples, only one of the spacing elements or less than all of the spacing elements may be formed in one unitary piece of material with the corresponding tubular support element(s).

According to yet another embodiment, an outer tubular support element diameter of the tubular support element ranges from 6 to 90 mm, and preferably from 20 to 60 mm. By outer tubular support element diameter is here meant the diameter of an outer tubular support element envelope wall. According to still another embodiment, a tubular support element thickness of a tubular support element envelope wall of the tubular support element ranges from 1 to 20 mm, and preferably from 3 to 10 mm. With the suggested diameter and thickness spans, the tubular support element seat and floor sides, as well as tubular support element envelope wall, may be of adequate dimensions in view of for instance load-bearing characteristics versus weight of the tubular support element. The suggested spans are furthermore adequate for an anchoring member to be encompassed. The tubular support element thickness may be constant along the perimeter and height of the tubular support element, or alternatively, vary along the envelope surface.

According to one embodiment, the spacer arrangement further comprises a primary reinforcing segment arranged between the first and second spacing elements. Thereby, the first and second spacing elements may be connected with each other, and the spacer arrangement be represented by a single part rather than two separate parts. Accordingly, handling as well as assembly of the spacer arrangement may be more convenient. It should be emphasized that the floor structure in itself, in this context, is not to be considered to be such a reinforcing segment. The primary reinforcing segment is preferably stiff, whereby additional strength is provided to the spacer arrangement. To provide a robust solution, the primary reinforcing segment is for instance represented by a beam. Notably, reinforcing segments may be utilized for the convenience of various surrounding equipment, such as fastening of a piece of equipment to a reinforcing segment.

According to another embodiment, the spacer arrangement further comprises at least a third spacing element and a fourth spacing element. Thereby, weight and loads applied to the seat may be distributed to the spacing elements in a suitable manner. For instance, two of the spacing elements may be arranged at positions corresponding to the front portion of the seat, and two other spacing elements at positions corresponding to the back portion. Furthermore, the front spacing elements may be of greater height than the height of the back spacing elements. Thereby, the at least four spacing elements may facilitate for a seat to be arranged slightly angled, subsequently supporting improved seat comfort.

According to yet another embodiment, the spacer arrangement further comprises a secondary reinforcing segment arranged between the first and third spacing elements, and/or a tertiary reinforcing segment arranged between the second and fourth spacing elements. Thereby, the first and third and/or second and fourth spacing elements may be connected with each other, whereby the spacer arrangement may be represented by a single part or a few parts rather than a plurality thereof. Accordingly, handling as well as assembly of the spacer arrangement may be more convenient. According to still another embodiment, the spacer arrangement further comprises one or several additional reinforcing segments arranged between the secondary and tertiary reinforcing segments.

As the secondary and/or tertiary reinforcing segments as well as the additional reinforcing segments are to be interpreted as similar or even identical to above mentioned primary reinforcing segment, similar advantages as those mentioned in conjunction with the primary reinforcing segment correspondingly apply.

### BRIEF DESCRIPTION OF THE DRAWINGS

The various aspects of the non-limiting embodiments of the invention, including particular features and advantages, will be readily understood from the following detailed description and the accompanying drawings, in which:

FIG. 1 illustrates an exemplifying spacer arrangement according to a first embodiment of the invention, for distancing a vehicle seat from a vehicle floor structure;

FIG. 2 shows the spacer arrangement of FIG. 1 in greater detail;

FIG. 3 shows a cross-section view of an exemplifying spacing element comprised in the spacer arrangement of FIG. 1; and

FIG. 4 illustrates a spacing element according to a second embodiment of the invention.

### DETAILED DESCRIPTION OF PREFERRED EMBODIMENTS

The non-limiting embodiments of the present invention will now be described more fully hereinafter with reference to the accompanying drawings, in which currently preferred embodiments of the invention are shown. This invention may, however, be embodied in many different forms and should not be construed as limited to the embodiments set forth herein. Like reference characters refer to like elements throughout.

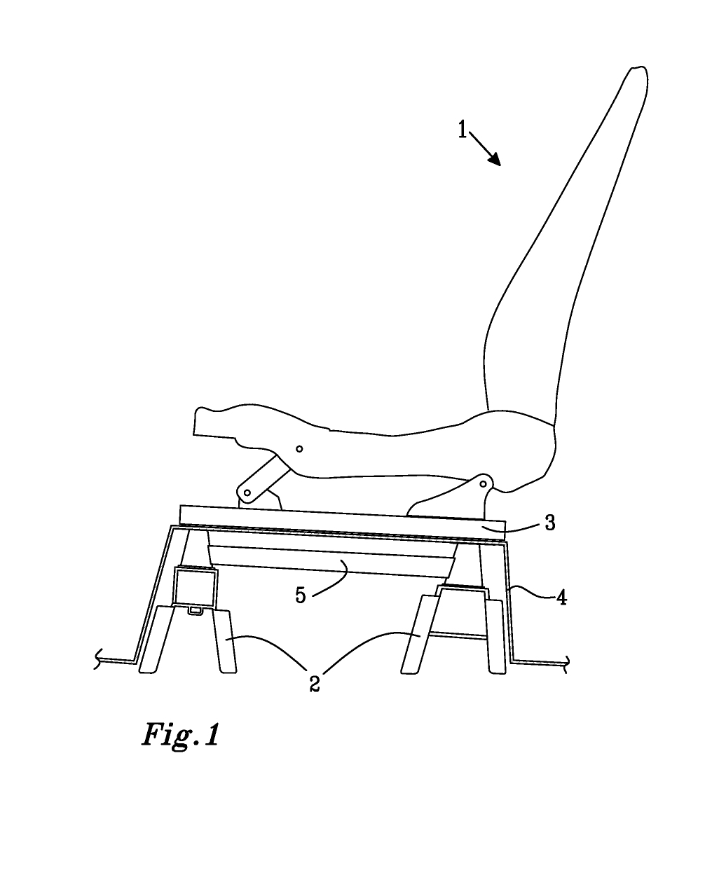

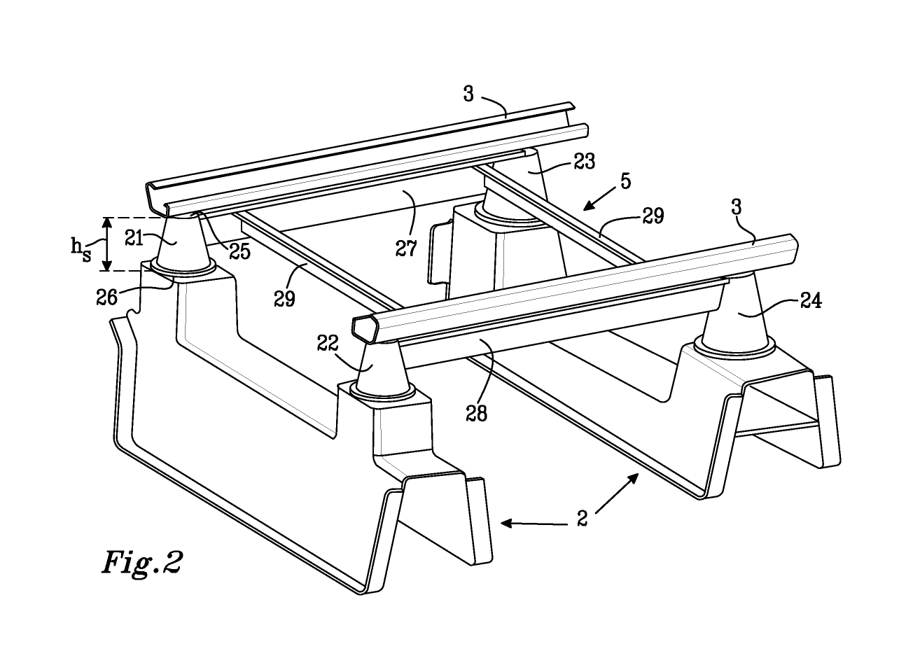

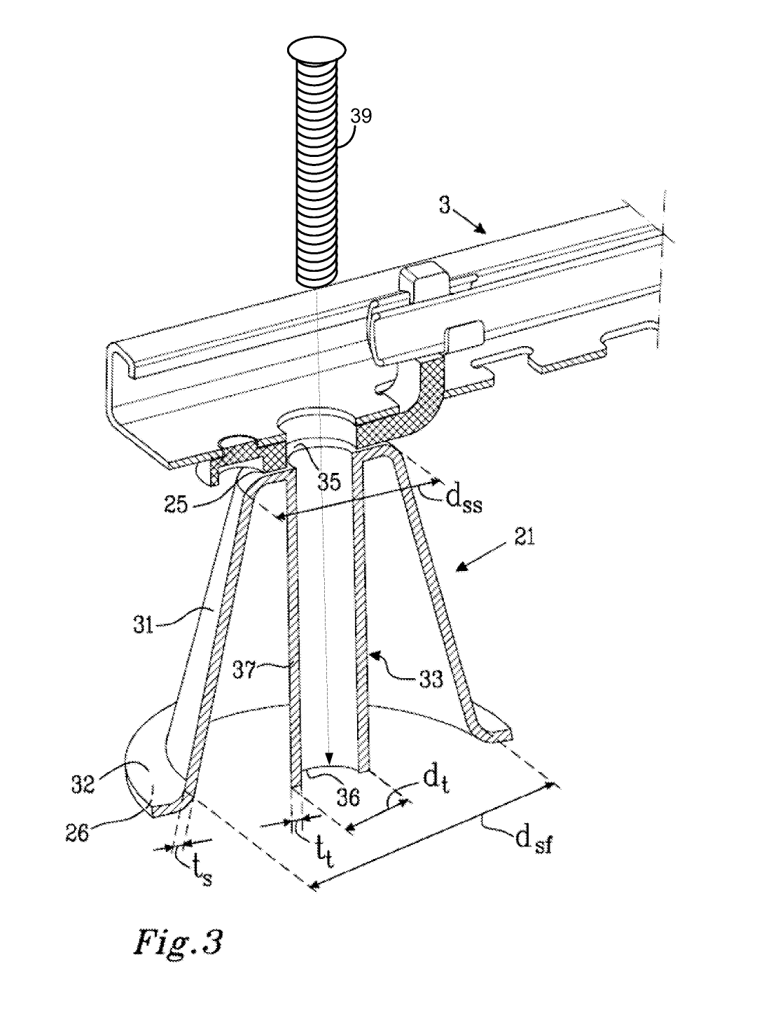

Referring now to the figures and FIG. 1 in particular, there is provided an exemplifying vehicle seat 1 and a corresponding vehicle floor structure 2, for instance vehicle chassis, onto which the seat 1 is to be arranged. The seat 1 is here provided with seat rails 3, for enabling the seat 1 to be adjustable in a forward and backward direction. Furthermore, the seat 1 is here a driver seat intended for a SUV, whereby the seat 1 is to be placed relatively high above the vehicle floor. Covering the floor structure 2 is a vehicle mat 4. In order to provide distancing of the seat 1 from the floor structure 2, an exemplifying spacer arrangement 5 according to a first embodiment is arranged between the seat 1, or more specifically the seat rails 3, and the floor structure 2. Specifics with regards to the spacer arrangement 5 will be provided with reference to FIGS. 2 and 3.

FIG. 2 shows the spacer arrangement 5 of FIG. 1 in greater detail, arranged between the seat rails 3 and the floor structure 2. The spacer arrangement 5 here comprises a first spacing element 21, a second spacing element 22, a third spacing element 23 and a fourth spacing element 24. Although dimensions of the respective spacing elements 21, 22, 23, 24 may vary, the characteristics of the respective spacing elements 21, 22, 23, 24 are similar or even identical, whereby a detailed description is solely given of the first spacing element 21. Accordingly, the first spacing element 21 has a spacing element seat side 25 adapted to be positioned towards the seat 1, or here rather the seat rails 3, and a spacing element floor side 26 adapted to be positioned towards the floor structure 2. The first spacing element 21 is of truncated cone shape flared from the spacing element seat side 25 towards the spacing element floor side 26. The first spacing element 21 is preferably, although not necessarily, manufactured of a light-weight material, and is in this exemplifying first embodiment manufactured from a magnesium based alloy. Furthermore, the first spacing element 21 is adapted to bear weight and loads applied to the seat 1, whereby the first spacing element 21 needs to take on suitable characteristics. Accordingly, the first spacing element 21 has a spacing element height hₛ stretching from the spacing element seat side 25 to the spacing element floor side 26. The spacing element height hₛ is here in the range of 60 to 100 mm, accordingly adapted for implementation in, for instance, a SUV. It should be noted that the spacing elements 21, 22, 23, 24 may be of different heights compared to each other depending on the implementation at hand; here, the first and second spacing elements 21, 22 are of height hₛ while third and fourth spacing elements 23, 24 are of a different height.

The exemplifying spacer arrangement 5 of this first embodiment further comprises an optional secondary reinforcing segment 27 arranged between the first and third spacing elements 21, 23, and an optional tertiary reinforcing segment 28 arranged between the second and fourth spacing elements 22, 24. Here, the reinforcing segments 27, 28 are shaped as beams. Additionally, the spacer arrangement 5 further comprises two optional additional reinforcing segments 29 arranged between the secondary and tertiary reinforcing segments 27 and 28.

FIG. 3 shows a cross-section view of the exemplifying first spacing element 21 of the first embodiment provided beneath the seat rail 3. The spacing element seat side 25 is here circular, and has an outer spacing element seat diameter dₛₛ, which preferably, although not necessarily, is in the range of 30 to 60 mm. Furthermore, the spacing element floor side 26 has an outer spacing element floor diameter d_{sf}, here in the range of 40 to 80 mm. The first spacing element 5 has a spacing element envelope wall 31, which envelope wall has a thickness tₛ here ranging from 1.5 to 5 mm. The spacing element thickness tₛ is here constant along the spacing element envelope wall 31 throughout the height hₛ of the spacing element. In this exemplifying first embodiment, the first spacing element 21 additionally comprises an optional brim 32 with a flange-like shape. The brim 32 is here an integrated section of the first spacing element 21, formed to encircle the spacing element floor side 26.

Accordingly, this first embodiment of the present invention presents a light-weight, space efficient spacer arrangement 5 for distancing the seat 1 from the floor structure 2, which spacer arrangement 5 comprises truncated cone-shaped spacing elements 21, 22, 23, 24 having sufficient characteristics to carry weight and loads applied to the seat 1.

The first spacing element 21 of the first embodiment additionally comprises an optional first tubular support element 33 centrally arranged inside the first spacing element 21. Here, the first spacing element 21 and the first tubular support element 33 are adapted for encompassing a single anchoring member 39, e.g. a relatively long screw or bolt. While FIG. 3 shows additional anchoring member 39 as a relatively long screw or bolt, anchoring member 39 may alternatively be a relatively long bolt, or another suitable device.

The first tubular support element 33 has a tubular support element seat side 35 adapted to be positioned towards the seat 1, here seat rail 3, and a tubular support element floor side 36 adapted to be positioned towards the floor structure 2. The tubular support element 33 is furthermore adapted to bear weight and loads applied to the seat 1. Accordingly, the tubular support element 33 needs to take on adequate characteristics, whereby the tubular support element seat side 35 here is in level with the corresponding spacing element seat side 25, and the tubular support element floor side 36 in level with the corresponding spacing element floor side 26. According to this first embodiment, the first spacing element 21 and the first tubular support element 33 are formed in one unitary piece of material, here a magnesium based alloy. The integration of the first tubular support element 33 with the first spacing element 21 is here accomplished in that the tubular support element seat side 35 is comprised in the spacing element seat side 25. An outer tubular support element diameter dₜ of the first tubular support element 33 is in the range of 20 to 60 mm. Additionally, a tubular support element thickness tₜ of a tubular support element envelope wall 37 of the first tubular support element 33 here ranges from 3 to 10 mm. Thereby, the first tubular support element 33 has sufficient characteristics to assist the first spacing element 21 in carrying weight and loads applied to the seat 1.

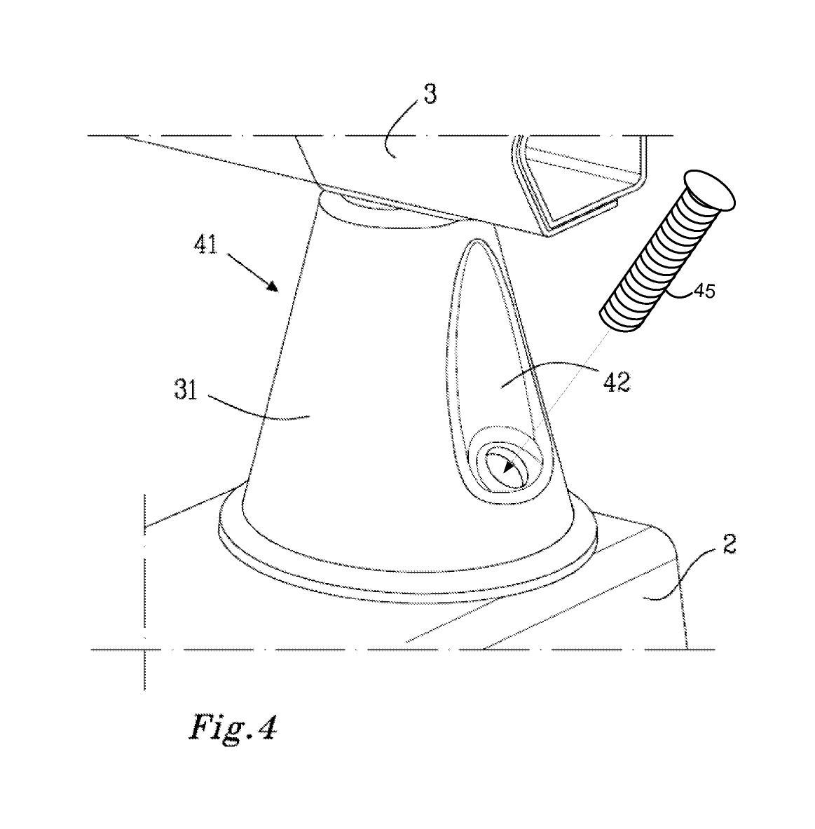

FIG. 4 illustrates a spacing element 41 according to a second embodiment of the invention. This alternative spacing element 41 allows for an additional anchoring member to pass through the spacing element wall 31, to thereby provide for additional fastening of the spacing element to the floor structure 2. Accordingly, the spacing element wall 31 according to this second embodiment comprises a cavity 42 adapted for fitting such an additional anchoring member 45. While FIG. 4 shows additional anchoring member 45 as a screw, anchoring member 45 may be a screw, a bolt, or another suitable device. As shown in FIG. 4, cavity 42 may include a recessed portion of wall 31, the recessed portion having a teardrop shape, such that a vehicle seat side of the cavity may be tapered relative to a vehicle floor side of the cavity which may be substantially rectangular with rounded edges. The recessed portion may have somewhat of an L-shape, with a rounded long leg of the L shape extending towards the tapered side of the cavity and a substantially planar short leg of the L shape extending outward from the long leg of the L shape at an angle (e.g., an angle greater than 90 degrees). An opening (e.g., a circular or oval opening) may be positioned on the short leg of the L shape. The opening may be shaped to receive the additional anchoring member 45. In some examples, an angle between an axis of anchoring member 45 and an axis of insertion of anchoring member 39 of FIG. 3 may be less than 90 degrees.

In other respects, the second embodiment may be identical to the first embodiment, and may include some or all of the other features of the first embodiment (e.g., spacing element 41 may or may not include a tubular support element and related features).

The person skilled in the art realizes that the present invention by no means is limited to the preferred embodiments described above. On the contrary, many modifications and variations are possible within the scope of the appended claims. It should furthermore be noted that the drawings not necessarily are to scale and the dimensions of certain features may have been exaggerated for the sake of clarity. Emphasis is instead placed upon illustrating the principle of the embodiments herein. Additionally, in the claims, the word “comprising” does not exclude other elements or steps, and the indefinite article “a” or “an” does not exclude a plurality.

1. A spacer arrangement for distancing a vehicle seat from a vehicle floor structure, said spacer arrangement comprising a first and a second spacing element, each having a spacing element seat side positioned towards said vehicle seat and a spacing element floor side positioned towards said vehicle floor structure, said first and second spacing elements being of a truncated cone or pyramid shape flared from said spacing element seat side towards said spacing element floor side, wherein said first and second spacing elements bear weight and loads applied to said vehicle seat.

2. The spacer arrangement in accordance with claim 1, wherein said first and/or said second spacing element comprises a light-weight material, such as one or more of the materials selected from the list of: aluminum, magnesium based alloys, and polymeric materials, such as composites and reinforced polymeric material such as carbon reinforced fiber polymeric material.

3. The spacer arrangement in accordance with claim 1, wherein said first and/or second spacing element has a spacing element height stretching from said spacing element seat side to said spacing element floor side, said spacing element height ranging from 10 mm to 150 mm, and preferably from 60 to 100 mm.

4. The spacer arrangement in accordance with claim 3, wherein said spacing element seat side is circular, and an outer spacing element seat diameter of said spacing element seat side ranges from 15 to 80 mm, and preferably from 30 to 60 mm.

5. The spacer arrangement in accordance with claim 4, wherein said spacing element floor side is circular, and an outer spacing element floor diameter of said spacing element floor side ranges from 20 to 100 mm, and preferably from 40 to 80 mm.

6. The spacer arrangement in accordance with claim 1, wherein at least one of said first and second spacing elements is monolithic and comprises a spacing element envelope wall defining a tubular void encompassing an anchoring member.

7. The spacer arrangement in accordance with claim 6, wherein a spacing element thickness of a spacing element envelope wall of said at least one of said first and second spacing elements ranges from 1 to 8 mm, and preferably from 1.5 to 5 mm.

8. A spacer arrangement for distancing a vehicle seat from a vehicle floor structure, said spacer arrangement comprising:
a first spacing element and a second spacing element each having a spacing element seat side positioned towards said vehicle seat and a spacing element floor side positioned towards said vehicle floor structure, said first and second spacing elements being of a truncated cone or pyramid shape flared from said spacing element seat side towards said spacing element floor side;
wherein at least one of the spacing elements comprises a tubular support element centrally arranged inside the corresponding spacing element, said tubular support element having a tubular support element seat side positioned towards said vehicle seat and a tubular support element floor side positioned towards said vehicle floor structure.

9. The spacer arrangement in accordance with claim 8, wherein at least one of the spacing elements is formed in one unitary piece of material with the corresponding tubular support element.

10. The spacer arrangement in accordance with claim 8, wherein an outer tubular support element diameter of said tubular support element ranges from 6 to 90 mm, and preferably from 20 to 60 mm.

11. The spacer arrangement in accordance with claim 10, wherein a tubular support element thickness of a tubular support element envelope wall of said tubular support element ranges from 1 to 20 mm, and preferably from 3 to 10 mm.

12. The spacer arrangement in accordance with claim 8, wherein said spacer arrangement further comprises a primary reinforcing segment arranged between said first and second spacing elements.

13. The spacer arrangement in accordance with claim 8, wherein said spacer arrangement further comprises at least a third spacing element, and a fourth spacing element.

14. The spacer arrangement in accordance with claim 13, wherein said spacer arrangement further comprises a secondary reinforcing segment arranged between said first and third spacing elements and/or a tertiary reinforcing segment arranged between said second and fourth spacing elements.

15. The spacer arrangement in accordance with claim 14, wherein said spacer arrangement comprises both the secondary reinforcing segment and the tertiary reinforcing segment, and wherein said spacer arrangement further comprises one or several additional reinforcing segments arranged between said secondary and tertiary reinforcing segments.

16. A spacer arrangement for distancing a vehicle seat from a vehicle floor structure, said spacer arrangement comprising a plurality of spacing elements each having a circular spacing element seat side positioned towards said vehicle seat and a circular spacing element floor side positioned towards said vehicle floor structure, said spacing elements being of a truncated cone or pyramid shape flared from said spacing element seat side towards said spacing element floor side, a wall of each spacing element comprising a cavity, the cavity receiving a first anchoring member fastening the spacing element to the vehicle floor structure.

17. The spacer arrangement of claim 16, wherein at least one of the spacing elements comprises a tubular support element centrally arranged inside the corresponding spacing element, said tubular support element having a tubular support element seat side positioned towards said vehicle seat and a tubular support element floor side positioned towards said vehicle floor structure, and said tubular support element receiving a second anchoring member fastening the vehicle seat to the vehicle floor structure.

18. The spacer arrangement of claim 17, wherein the cavity has a teardrop shape and includes an opening receiving the first anchoring member.

19. The spacer arrangement of claim 18, wherein at least one of the plurality of spacing elements further comprises a brim with a flange-like shape.

20. The spacer arrangement of claim 17, wherein at least one of the spacing elements is formed in one unitary piece of material with the corresponding tubular support element.
